(19) United States
(12) Patent Application Publication
(10) Pub. No.: US 2019/0082066 A1
(43) Pub. Date: Mar. 14, 2019

(54) INFORMATION PROCESSING APPARATUS AND METHOD OF CREATING EXTERNAL CONTROL APPLICATION FOR CONTROLLING THE SAME

(71) Applicants: KABUSHIKI KAISHA TOSHIBA, Tokyo (JP); TOSHIBA TEC KABUSHIKI KAISHA, Tokyo (JP)

(72) Inventor: Shunichi Megawa, Tagata Shizuoka (JP)

(21) Appl. No.: 15/704,230

(22) Filed: Sep. 14, 2017

(51) Int. Cl. H04N 1/00; G06F 9/44

(52) U.S. Cl. CPC H04N 1/00514; G06F 8/38; H04N 1/00352; H04N 1/00493

(57) ABSTRACT

In accordance with an embodiment, an information processing apparatus comprises a communication interface and a processor. The communication interface communicates with an external device. The processor provides a selection screen for selecting a function realized by an external control application and creates an external control application executable by the external device in response to a content designated by an administrator on the selection screen.

### FIELD

Embodiments described herein relate generally to an information processing apparatus and a method/system of creating an external control application for controlling the same.

### BACKGROUND

Conventionally, an information processing apparatus such as a printer, a scanner and a digital multi-functional peripheral has a function that can be controlled from an external device connected to the information processing apparatus in a communicable manner. The function of controlling the information processing apparatus with the external device is provided by an external control application (application program) installed in the external device. However, conventionally, there is a problem that the function provided by the external control application distributed to a user cannot be customized by an administrator.

### DESCRIPTION OF THE DRAWINGS

FIG. 1 is a block diagram exemplifying the constitution of a digital multi-functional peripheral (MFP) according to an embodiment;

FIG. 2 is a block diagram exemplifying the constitution of an external device according to the embodiment;

FIG. 3 is a sequence diagram illustrating the flow of an application customization processing by the digital MFP and the external device according to the embodiment;

FIG. 4 is a flowchart exemplifying the operation of the digital MFP according to the embodiment;

FIG. 5 is a diagram exemplifying a display of a designed selection screen of an application displayed by the digital MFP according to the embodiment;

FIG. 6 is a diagram exemplifying the display of the designed selection screen of the application displayed by the digital MFP according to the embodiment;

FIG. 7 is a diagram exemplifying the display of the designed selection screen of the application displayed by the digital MFP according to the embodiment;

FIG. 8 is a diagram exemplifying the display of the designed selection screen of the application displayed by the digital MFP according to the embodiment;

FIG. 9 is a diagram exemplifying the display of the designed selection screen of the application displayed by the digital MFP according to the embodiment;

FIG. 10 is a diagram exemplifying a display by the external device installing the application created by the digital MFP according to the embodiment; and

FIG. 11 is a diagram exemplifying the display by the external device installing the application created by the digital MFP according to the embodiment.

### DETAILED DESCRIPTION

In accordance with an embodiment, an information processing apparatus comprises a communication interface and a processor. The communication interface communicates with an external device. The processor provides a selection screen for selecting a function realized by an external control application and creates the external control application executable by the external device in response to a content designated by an administrator on the selection screen.

In accordance with an embodiment, a system for controlling an information processing apparatus comprises an external device comprising an external device processor and a display, the external device processor configured to display a management screen on the display, and the display configured to display options for selecting a creation processing of an external control application on the management screen; and the information processing apparatus comprises a communication interface configured to communicate with the external device; and an information processing apparatus processor configured to provide a selection screen for selecting a function realized by the external control application and create the external control application executable by the external device in response to a content designated by an administrator on the selection screen.

Hereinafter, an embodiment is described with reference to the accompanying drawings.

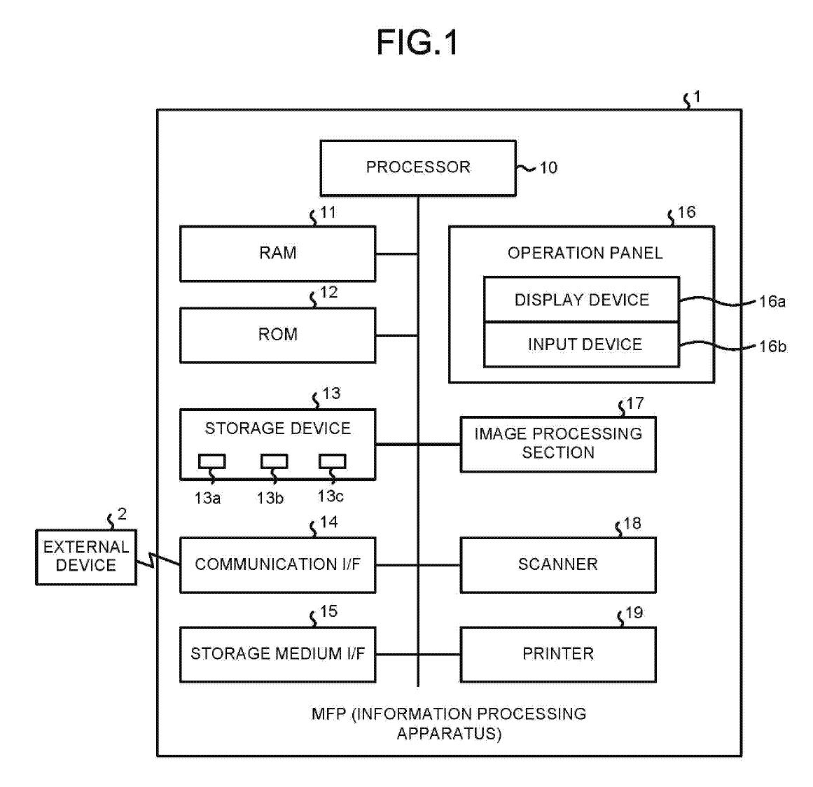

FIG. 1 is a block diagram exemplifying the constitution of a digital multi-functional peripheral (MFP) 1 as an information processing apparatus according to the embodiment.

The MFP 1 is an example of the information processing apparatus. The MFP 1 is an image processing apparatus (a printing apparatus, an image reading apparatus, a copying apparatus, etc.) that executes image processing such as printing, scanning and copying. However, the information processing apparatus may be any device as long as it can access an external device 2 which installs an application program (hereinafter referred to as an “external control AP”) generated by a processing described later. In the present embodiment, it is assumed that the information processing apparatus is the MFP 1 and the external device 2 is a PC or a mobile terminal having a communication function with the MFP 1.

As shown in FIG. 1, the MFP 1 includes a processor 10, a RAM 11, a ROM 12, a storage device 13, a communication I/F 14, a storage medium I/F 15, an operation panel 16, an image processing section 17, a scanner 18, and a printer 19.

The processor 10 realizes various processing by executing a program. The processor 10 is, for example, a CPU (central processing unit). The processor 10 is connected to each section in the MFP 1 via a bus line. The processor 10 executes various processing by executing a program stored in the ROM 11 or the storage device 13. For example, the processor 10 executes a basic operation control of the MFP 1 by executing the program of an OS (Operating System). The processor 10 executes various processing by executing the application program (hereinafter, also referred to as an application (AP)) designed according to processing contents.

Furthermore, the RAM 11 and the ROM 12 constitute a system memory used for the processor 10 to operate. The RAM 11 is a volatile memory. The RAM 11 is used as a work area for temporarily storing data to be used. The ROM 12 is a nonvolatile memory. The ROM 12 stores various programs such as the OS program or the application program executed by the processor 10.

The storage device 13 is a rewritable nonvolatile memory. The storage device 13 is composed of memory devices such as an HDD (hard disk drive), an SSD (solid state drive) or an EEPROM® Technology (electric erasable programmable read-only memory), for example. The storage device 13 stores data used in various processing executed by the processor 10. For example, the storage device 13 stores setting information for operating the MFP 1. The storage device 13 may store the OS or the application.

In the present embodiment, the storage device 13 has a storage area 13a for storing an application for operating the MFP 1 as a Web server. The storage device 13 has a storage area 13b for storing data (log data, setting information, etc.) that can be browsed from the external device by setting. The storage device 13 has a storage area 13c for storing an external control AP (a model of the external control AP) in an initial state which is the source of the external control AP created by a later-described processing.

The communication I/F 14 is used for data communication. In the present embodiment, the communication I/F 14 functions as an interface for communicating with the external device 2. The communication I/F 14 may communicate with the external device 2 via a network, or may communicate with the external device 2 without using the network. The communication I/F 14 may perform the communication in a wireless or wired manner. For example, the communication I/F 14 communicates with the external device 2 via a network including a wireless LAN or a wired LAN. The communication I/F 14 may communicate with the external device 2 via a network including a WAN (wide area network). Furthermore, the communication I/F 14 may include an I/F for performing a near field wireless communication. The near field wireless communication may include communication by a non-contact communication such as an NFC.

The storage medium I/F 15 is used for writing information in a storage medium. For example, the storage medium I/F 15 may connect with a portable external memory device. The storage medium I/F 15 may write data in an optical disk or a magnetic storage medium. The storage medium I/F 15 may be a card reader/writer for writing data in a card such as an IC card. In the present embodiment, the storage medium I/F 15 has a function of writing the application program (external control AP) created by a later-described processing in the storage medium.

The operation panel 16 is used by a user or an administrator to operate the MFP 1. The operation panel 16 has a display device 16a and an input device 16b. The display device 16a displays information. The display device 16a is composed of, for example, a liquid crystal display or an organic EL (Electro-Luminescence) display. The input device 16b receives an operation by an operator (user or administrator). The input device 16b is composed of, for example, a touch panel, a keyboard, a numeric keypad, and the like. For example, the operation panel 16 may be a display panel (display device 16a) having a touch panel as the input device 16b.

The image processing section 17 is used for processing an image. The image processing section 17 may be composed of dedicated hardware such as an image processing circuit or may be realized by executing a program by the processor. For example, the image processing section 17 processes an image scanned by the scanner 18 in a scanning processing. The image processing section 17 generates an image output to the printer 19 in a printing processing.

The scanner 18 reads an image on an original document as image data. For example, the scanner 18 optically scans the image on the original document to acquire the image data. In this case, the scanner 18 includes an image capturing device such as a CCD (Charge-Coupled Device) image sensor and an optical system for guiding light from the original document to the image capturing device. The scanner 18 may read the image by other methods.

The printer 19 prints an image on an image receiving medium such as a paper. The printer 19 is not limited to the constitution of a specific image forming system. For example, the printer 19 may be an electrophotographic system, an inkjet system, or a thermal transfer system. In the present embodiment, the printer 19 is a printer of the electrophotographic system.

Next, the constitution of the external device 2 is described.

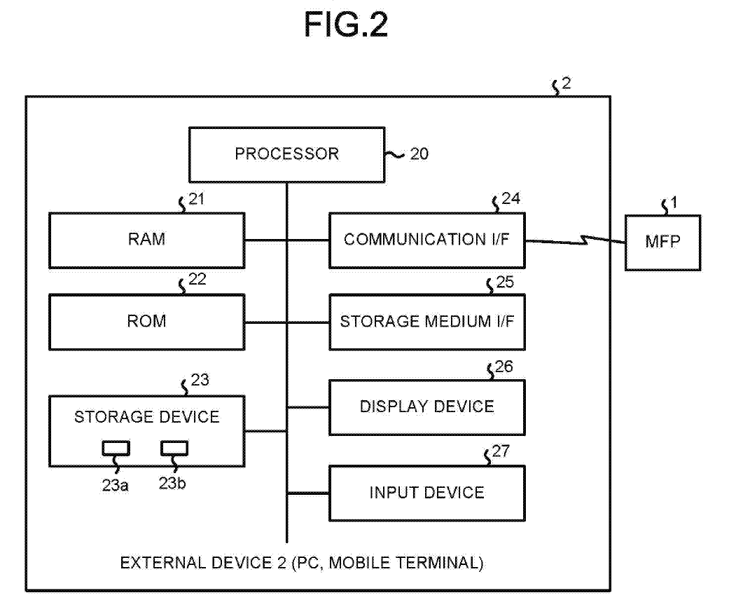

FIG. 2 is a block diagram exemplifying the constitution of the external device 2 according to the embodiment.

The external device 2 is an electronic device capable of connecting to the MFP 1 in a communicable manner. The external device 2 is used by the administrator or the user. The external device 2 functions as a management device operated by the administrator or a user terminal operated by the user. The external device 2 may be a PC (such as a desktop PC or a notebook PC) or a mobile terminal (a smartphone, a tablet PC, a mobile phone, etc.). In the present embodiment, the external device 2 has a function of accessing a Web page provided by the MFP 1 as a Web server through a Web browser.

As shown in FIG. 2, the external device 2 has a processor 20, a RAM 21, a ROM 22, a storage device 23, a communication I/F 24, a storage medium I/F 25, a display device 26, and an input device 27.

The processor 20, the RAM 21, and the ROM 22 constitute a controller for controlling the external device 2. The processor 20 realizes various processing functions by executing programs. The processor 20 is, for example, a CPU. The processor 20 connects with each section in the external device 2 via a bus line. The processor 20 executes various processing by executing programs stored in the ROM 21 or the storage device 23. For example, the processor 20 executes a basic operation control of the external device 2 by executing a program of the OS (Operating System). The processor 20 executes various processing by executing an application program designed in response to processing content.

Furthermore, the RAM 21 and the ROM 22 constitute a system memory for the processor 20 to operate. The RAM 21 is a volatile memory. The RAM 21 is used as a work area for temporarily storing data to be used. The ROM 22 is a nonvolatile memory. The ROM stores various programs such as an OS program or an application program executed by the processor 20.

The storage device 23 is a rewritable nonvolatile memory. The storage device 23 is composed of, for example, an HDD, an SSD or an EEPROM® Technology. The storage device 23 stores various application programs, control data and user data. The storage device 23 has storage areas 23a and 23b for storing the applications.

The storage device 23a stores a Web browser as an application for accessing the MFP 1 as the Web server. The processor 20 accesses the MFP 1 operating as the Web server by executing the Web browser stored in the storage area 23a.

The storage device 23b stores an external control AP (AP for controlling the MFP) created by the MFP 1 by a later-described processing. By executing the external control AP stored in the storage area 23b, the processor 20 realizes setting and information browsing for the MFP 1. For example, the external control AP may perform control to change the setting of the MFP 1 by SNMP communication or SOAP communication and acquire information from the MFP 1.

The communication I/F 24 is used for data communication. In the present embodiment, the communication I/F 24 functions as an interface for communicating with the MFP 1. The communication I/F 24 may communicate with the MFP 1 via the network, or may communicate with the MFP 1 without using the network. The communication I/F 24 may perform the communication in a wireless or wired manner. For example, the communication I/F 24 communicates with the MFP 1 via the network including the wireless LAN or the wired LAN. The communication I/F 24 may communicate with the MFP 1 via the network including the WAN (wide area network). Furthermore, the communication I/F 24 may include an I/F for performing the near field wireless communication. The near field wireless communication may include communication by a non-contact communication such as the NFC.

The storage medium I/F 25 is used for writing information in the storage medium. For example, the storage medium I/F 25 may connect with a portable external memory device. The storage medium I/F 25 may write data in the optical disk or the magnetic storage medium. The storage medium I/F 25 may be a card reader/writer for writing data in the card such as the IC card. In the present embodiment, the storage medium I/F 25 may have a function of reading the external control AP from a storage medium which records the external control AP created by the MFP 1. In this case, the processor 20 performs a processing of writing (installing) the external control AP read from the storage medium by the storage medium I/F in the storage area 23b.

The display device 26 is constituted by a display device. A display content of the display device 26 is controlled by the processor 20. The input device 27 is constituted by a touch panel, a numeric keypad, a keyboard and the like. The input device 27 supplies an operation instruction input by the user or the administrator to the processor 20. For example, the display device 26 and the input device 27 are constituted by a display device attached with a touch panel.

Next, the operations of the MFP 1 and the external device 2 according to the present embodiment are described.

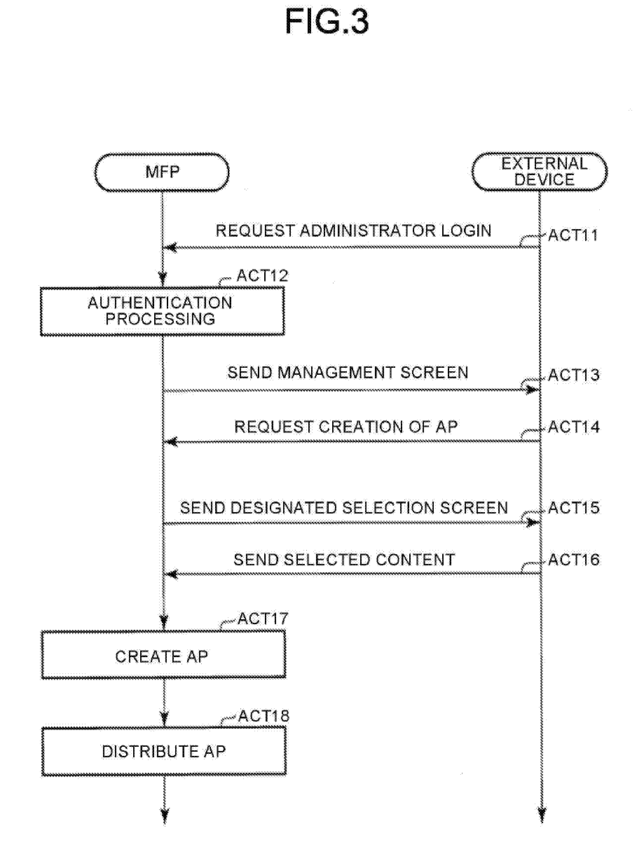

FIG. 3 is a sequence diagram schematically exemplifying the operations of the MFP 1 and the mobile terminal 2 accompanied with creation of the external control AP by the MFP 1 according to the present embodiment.

Here, the flow of an application creation processing for creating the external control AP by the MFP 1 in response to an instruction from the administrator who operates the external device 2 is described. In a case of creating the external control AP provided to the user, the administrator operates the input device 27 of the external device 2 to input information for logging in the MFP 1 as the administrator. If the administrator inputs the login information, the processor 20 of the external device 2 sends a login request as the administrator together with the input login information to the MFP 1 (ACT 11).

In a case of receiving the login request from the external device 2, the processor 10 of the MFP 1 executes an authentication processing based on the received login information (ACT 12). For example, if the received login information is coincident with the registered information of the administrator, the processor 10 determines that the authentication is successful and allows the login as the administrator. If the authentication as the administrator succeeds, the processor 10 of the MFP 1 transmits a management screen that can be used by the administrator to the external device 2 (ACT 13). If the authentication fails, the processor 10 sends a message indicating that the authentication fails to the external device 2.

In a case of receiving the management screen, the processor 20 of the external device 2 displays the management screen on the display device 26. The management screen is, for example, a menu screen for the administrator to select the processing that can be used by the administrator. The display device 26 displays options for selecting a creation processing of the external control AP on the management screen. The administrator selects and instructs the creation processing of the external control AP using the input device 27 on the management screen displayed by the display device 26. If the creation processing of the external control AP is selected, the processor 20 of the external device 2 transmits a request to create the external control AP to the MFP 1 (ACT 14).

In a case of receiving the request to create the external control AP, the processor 10 of the MFP 1 starts a processing for creating the external control AP. The processor 10 of the MFP 1 transmits a designed selection screen to the external device 2 which is used for the administrator to select (designate) the function realized by the external control AP (ACT 15). The designed selection screen is used by the administrator to select (designate) setting items that can be set by the created external control AP and information that can be browsed. In the designed selection screen, it is also possible to designate an expiration date of the created external control AP, a user providing (using) the external control AP, a distribution method of the external control AP, and the like.

The processor 20 of the external device 2 receives the designed selection screen for creating the external control AP from the MFP 1 after transmitting the request for creating the external control AP. In a case of receiving the designed selection screen, the processor 20 displays the designed selection screen received from the MFP 1 on the display device 26. If the designed selection screen is displayed, the processor 20 selects and instructs the function for enabling the external control AP created by using the input device 27. If the designed selection screen is selected, the processor 20 transmits information indicating the selected content to the MFP 1 (ACT 16).

In a case of receiving the information indicating the selected content from the external device 2, the processor 10 of the MFP 1 creates the external control AP in response to the selected content (ACT 17). The processor 10 creates (customizes) the external control AP by combining the selected content in the application model stored in the storage area 13c of the storage device 13. For example, the processor 10 creates the external control AP limited to the function designated by the administrator. The processor 10 may set a usable period and information for specifying a user who uses the external control AP in the created external control AP in response to designation from the administrator.

In a case of creating the external control AP, the processor 10 distributes the created external control AP to each user (ACT 18). The processor 10 distributes the created external control AP to the user designated by a distribution method designated by the administrator or a predetermined distribution method. The distribution method of the external control AP may be an optional method as long as it is a method capable of enabling the created external control AP to be installed in the external device 2 held (used) by the user designated by the administrator. For example, the processor 10 may store the created external control AP in the storage device 13 and notify each user of linked information for accessing the stored external control AP. The processor 10 may transmit the created external control AP to each user by e-mail. The processor 10 may record the created external control AP in a portable storage medium (the external memory device, the optical disk, the magnetic disk, the IC card, etc.) distributed to each user.

Next, the operation of the MFP 1 according to the present embodiment is further described in detail.

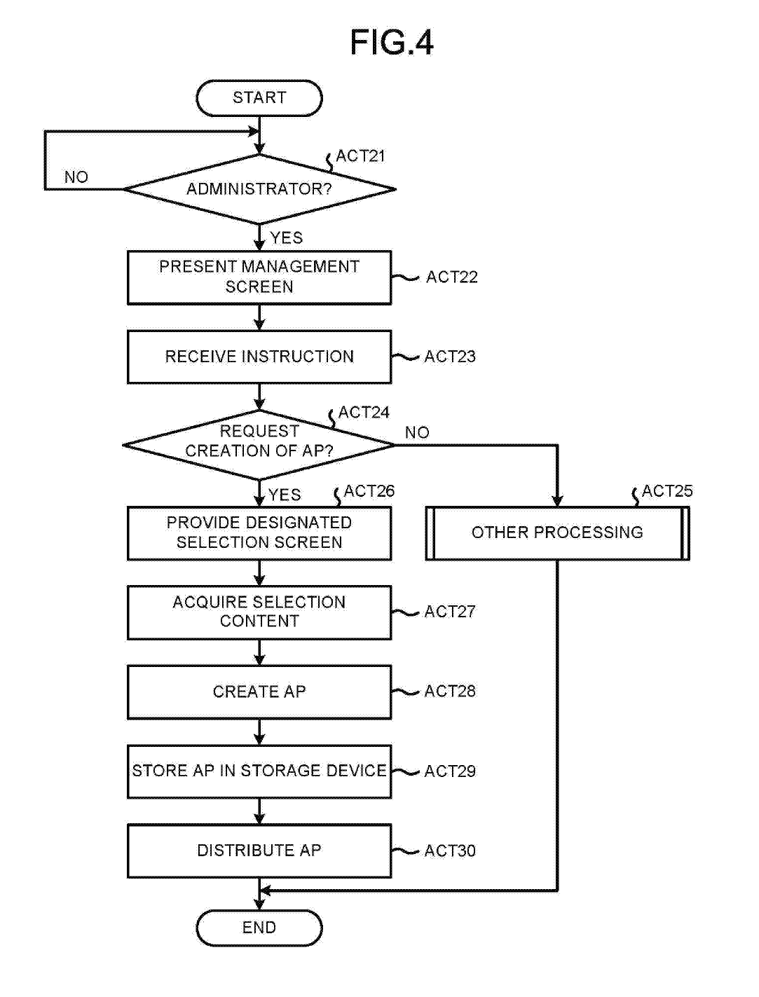

FIG. 4 is a flowchart illustrating the flow of the application creation processing by the MFP 1 according to the present embodiment.

The processor 10 of the MFP 1 receives an access from the external device 2 as the function of the Web server. In a case of receiving the login request as the administrator from the external device 2, the processor 10 executes the authentication processing of the administrator based on the login information received together with the login request. If it is confirmed that the login from the administrator is made by the authentication processing (Yes in ACT 21), the processor 10 transmits the management screen provided to the administrator to the external device 2 (ACT 22).

After transmitting the management screen, the processor 10 of the MFP 1 receives a request for selectable processing on the management screen (ACT 23). On the management screen, various processing including creation of the external control AP which can be executed by the instruction of the administrator can be selected. In a case of receiving the information indicating the processing selected from the external device 2, the processor 10 determines whether or not the processing selected with the external device 2 is the creation processing of the external control AP (ACT 24). If a processing other than the creation processing of the external control AP is instructed (No in ACT 24), the processor 10 executes the selected processing (ACT 25).

If the creation processing of the external control AP is instructed (Yes in ACT 24), the processor 10 transmits the designed selection screen for inputting the information for creating the external control AP to the external device 2 (ACT 26). In the external device 2 operated by the administrator, the designed selection screen from the MFP 1 is displayed to receive an instruction input by the administrator. The MFP 1 provides the designed selection screen through which the administrator designates a function (or a function to disable) to enable the created external control AP. The MFP 1 allows the administrator to designate the usable period of the external control AP, the user who can use it, the distribution method, and the like through the designed selection screen.

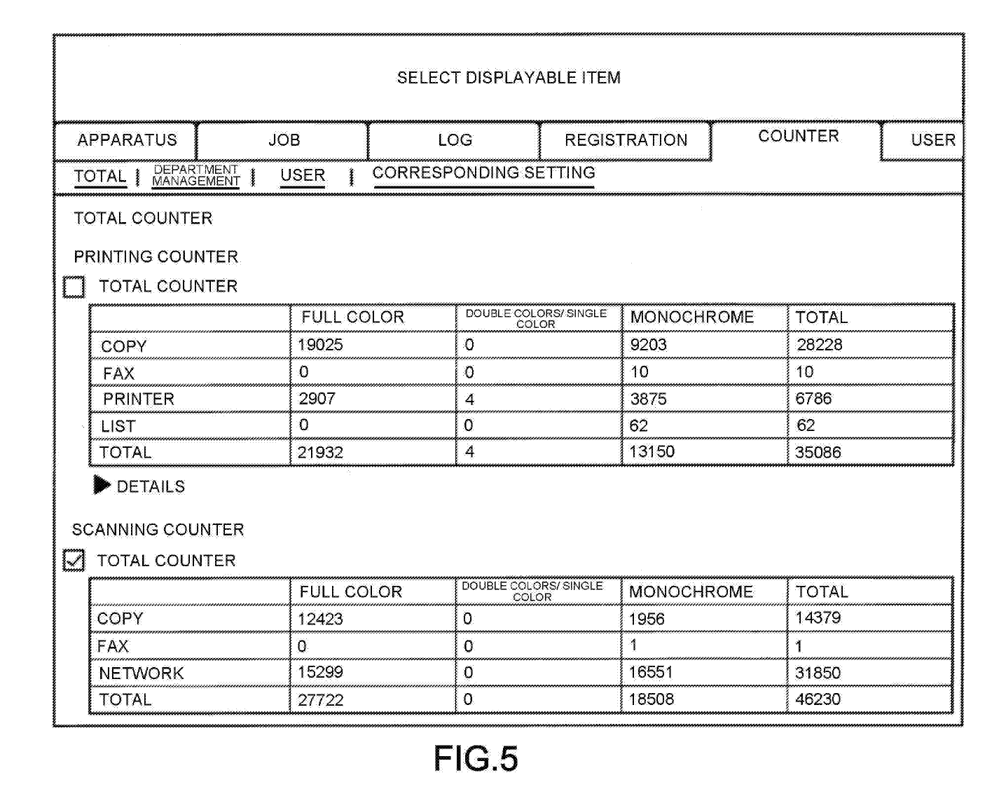

FIG. 5 to FIG. 9 are diagrams illustrating an example of the designed selection screen that the MFP 1 provides to the external device 2.

FIG. 5 is a diagram illustrating an example of the designed selection screen for selecting the information displayable by the created external control AP. In the example shown in FIG. 5, a state in which a printing counter is not selected, but the scanning counter is selected as a total counter is shown. According to the setting, the processor 10 of the MFP 1 creates the external control AP whose printing counter cannot be viewed and whose scanning counter can be viewed.

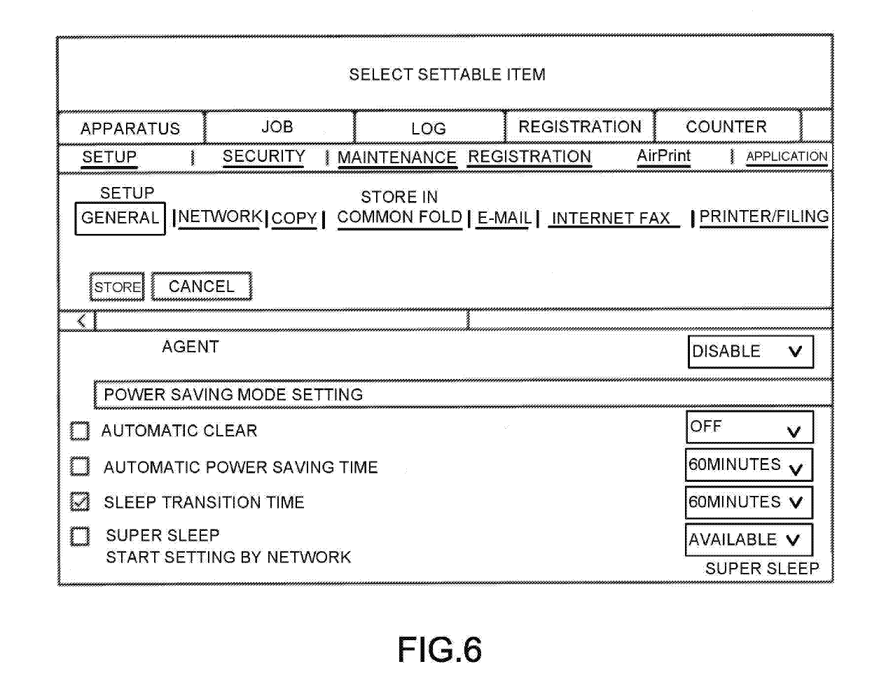

FIG. 6 is a diagram illustrating an example of the designed selection screen for selecting the setting items capable of changing setting by the created external control AP. In the example shown in FIG. 6, as a power saving mode setting, a state in which a sleep transition time is selected and the other items (automatic clear, automatic power saving time, and super sleep) are not selected is shown. According to the setting, the processor 10 of the MFP 1 creates the external control AP capable of changing the sleep transition time in the power saving mode setting.

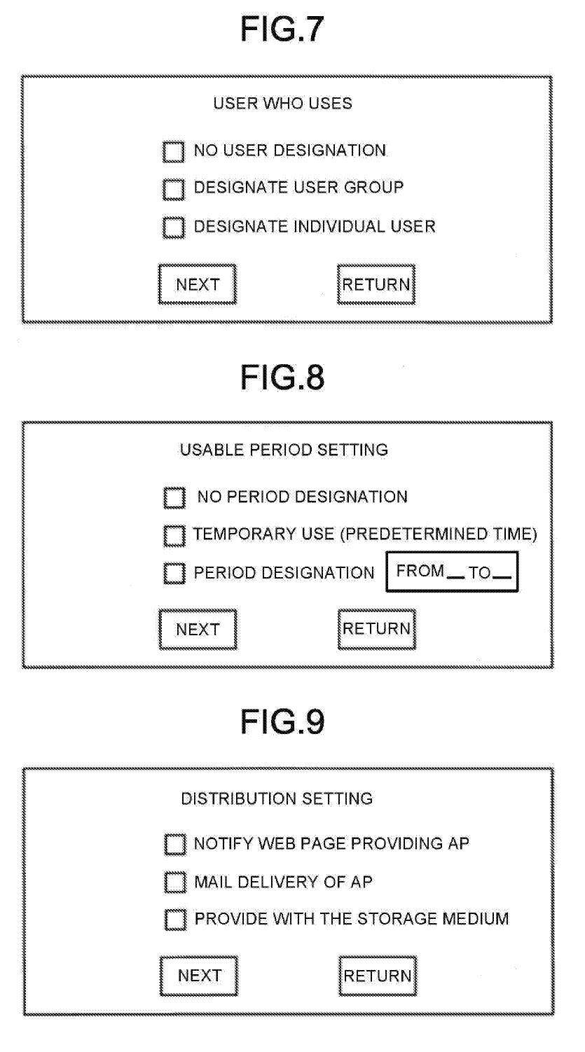

FIG. 7 is a diagram illustrating an example of the designed selection screen for selecting (designating) the user who uses the created external control AP. In the example shown in FIG. 7, all users (without user designation), user group designation, and individual user designation can be selected as users who can use the external control AP. For example, an account and a password are designated as information for specifying the user who can use the external control AP. If a user who can use the external control AP is designated, the processor 10 of the MFP 1 creates the external control AP in which information specifying the user (for example, the account and the password) is set. The processor 10, for example, sets the account and the password in the created external control AP. The external control AP in which the account and the password are set prevents a user who does not have account and password coincident with the set account and password from using the external control AP.

FIG. 8 is a diagram illustrating an example of the designed selection screen for selecting (specifying) the usable period during which the created external control AP becomes usable. In the example shown in FIG. 8, no period designation, temporary use (predetermined time), or period designation can be selected as the usable period. As the temporary use, it is possible to designate a period within a predetermined time (for example, several minutes) from distribution. As the period designation, the administrator can designate an arbitrary period. If the usable period is designated, the processor 10 of the MFP 1 creates the external control AP that operates effectively within the usable period.

FIG. 9 is a diagram illustrating an example of the designed selection screen for selecting (specifying) the distribution method of the created external control AP. In the example shown in FIG. 9, notification of the web page (linked information) providing the AP, mail delivery of the AP, or providing with the storage medium can be selected as the distribution method of the external control AP. If the notification of the Web page providing the AP is designated, the processor 10 notifies the user of the Web page (linked information) for accessing the created external control AP. If the mail delivery of the AP is designated, the processor 10 delivers the created external control AP to the user by e-mail. If providing by the storage medium is designated, the processor 10 writes the created external control AP in the portable storage device (the external memory device, the optical disk, the magnetic storage medium, etc.).

In the state in which the designed selection screen is displayed as described above, in the external device 2, the administrator inputs the selection and designation of each item. The external device 2 transmits the information input by the administrator to the MFP 1.

In a case of receiving the information indicating the selected contents from the external device 2, the processor 10 of the MFP 1 creates the external control AP in response to the selected contents (ACT 17). The processor 10 creates (customizes) the external control AP by combining the selected contents with the model of the external control AP stored in the storage area 13c of the storage device 13. For example, the processor 10 creates the external control AP which restricts the executable function to only the function designated by the administrator for the external control application to the initial state stored in the storage area 13c. If the usable period is designated, the processor 10 sets the usable period in the created external control AP. If the user who can use the created external control AP is designated, the processor 10 creates the external control AP in which the information (for example, account and password) for specifying the designated user is set.

In a case of creating the external control AP, the processor 10 stores the created external control AP in the storage device (ACT 29) and distributes it to the user (ACT 30). The distribution method of the external control AP can be any form as long as it is a method capable of installing the created external control AP in the external device 2 held (used) by the user. The distribution method of the external control AP may be designated by the administrator in the designed selection screen as shown in FIG. 9, or may be set in advance.

In the creation processing described above, the contents of the created external control AP are designated (selected) by the administrator in the external device 2, but it is not limited thereto. The contents of the external control AP may be designated in the operation panel 16 of the MFP 1. This can be realized by replacing the above-mentioned operation of the external device 2 with an operation performed by the operation panel 16. In other words, the administrator who logs in by operating the operation panel 16 may designate the contents of the created external control AP by operating the operation panel 16.

Through the above processing, the MFP 1 creates the external control AP customized according to the contents designated by the administrator with the external device 2, and distributes the created external control AP to each user. The external device (user terminal) 2 operated by each user to which the created external control AP is distributed installs the distributed external control AP. As a result, the external device 2 as the user terminal can change the setting or browse the information of the MFP 1 by the function given to the distributed external control AP.

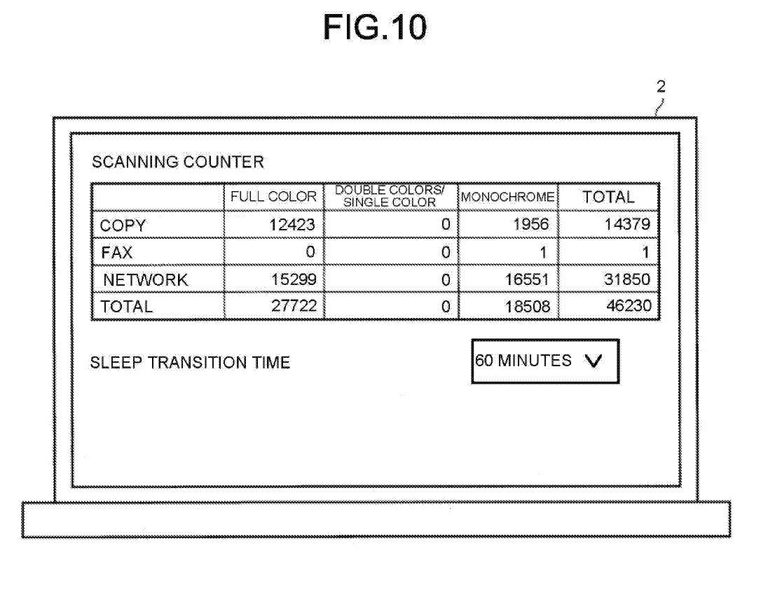

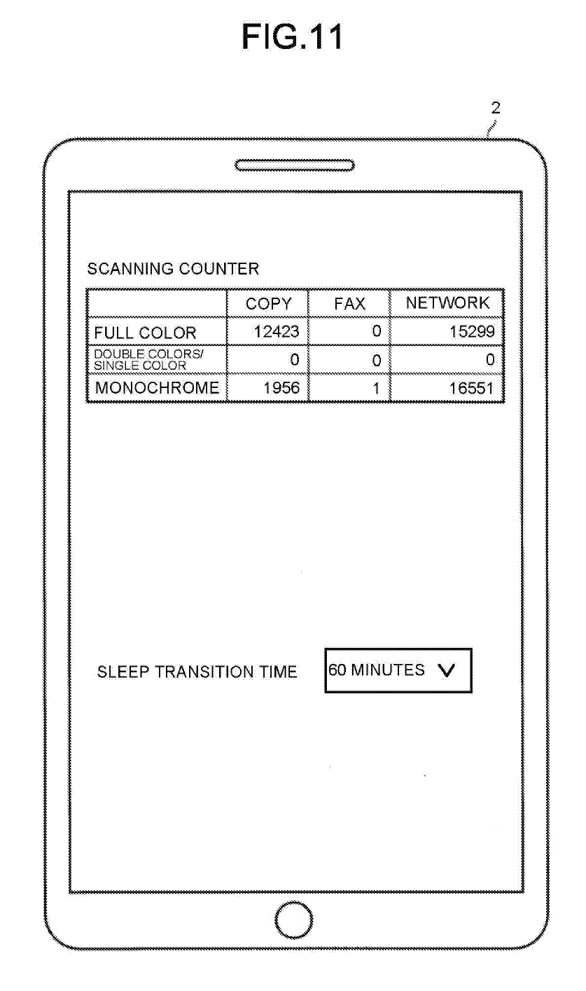

FIG. 10 and FIG. 11 are diagrams illustrating examples of a case in which the external control AP created by the MFP 1 is executed by the external device 2 as the user terminal. FIG. 10 is a diagram illustrating an example of executing the external control AP by the PC as the external device 2. FIG. 11 is a diagram illustrating an example if the external control AP is executed by the mobile terminal as the external device 2.

In the examples shown in FIG. 10 and FIG. 11, the scanning counter selected by the designed selection screen in FIG. 5 is displayed on the display device of the external device 2. In this way, it is possible to provide the external control AP which controls the external device to display only the information selected by the administrator, without displaying the information not selected by the administrator.

In the examples shown in FIG. 10 and FIG. 11, the display device of the external device 2 displays a screen on which the sleep transition time selected by the designed selection screen in FIG. 6 can be set. In this manner, it is possible to provide the external control AP that performs control so that only the setting item selected by the administrator can be input by the external device without changing the setting items not selected by the administrator.

According to the above embodiment, the MFP 1 can create the external control AP (application program) customized in response to the contents designated by the administrator on the external device 2. According to the above-described application creation processing, it is possible to easily create an application (the external control AP) limited to functions designated by the administrator. As a result, the administrator can easily and properly create the external control AP customized according to an operational status or a user, and distribute the external control AP designed as necessary to the user.

For example, it is technically possible that a fixed AP is provided to the user, and the MFP controls the validity or invalidity of the function according to a user authority. However, the application administrator considers a use case in which the executable function is desired to be controlled depending on a user or time for the image processing apparatus using the application. In such a case, in the method of providing the fixed AP to the user, the function of the MFP which is desired to be disabled for the user is also presented to the user, resulting in low operability and convenience. It is also possible for a vendor side to provide a plurality of APs combining plural patterns of validity or invalidity for each function in advance. However, the combination of functions whose validity and invalidity are set depending on the situation is enormous. It is not realistic to cover all cases.

In this case, in the present embodiment, the MFP creates the external control AP limited to the functions designated by the administrator to distribute it. Thus, the external control AP having the function limited to the free combination desired by the administrator can be provided to the user as appropriate. As a result, it is possible to provide the MFP and the externality control AP with high convenience.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. An information processing apparatus, comprising:
a communication interface configured to communicate with an external device; and
a processor configured to provide, to the external device, a selection screen for selecting a function realized by an external control application and create the external control application executable by the external device in response to a content designated by an administrator on the selection screen of the external device, wherein the external control application controls at least one function of the information processing apparatus.

2. The information processing apparatus according to claim 1, further comprising:
a memory configured to store the external control application in an initial state, wherein
the processor creates the external control application executable by the external device by updating the external control application in the initial state stored in the memory in response to the content designated by the administrator.

3. The information processing apparatus according to claim 1, wherein
the processor creates the external control application having a function of changing a setting item designated by the administrator to a value designated by a user on the external device.

4. The information processing apparatus according to claim 1, wherein
the processor creates the external control application having a function of enabling information designated by the administrator to be browsed on the external device.

5. The information processing apparatus according to claim 1, wherein
the processor creates the external control application that operates effectively in a usable period designated by the administrator.

6. The information processing apparatus according to claim 1, wherein
the processor creates the external control application that is usable by the user designated by the administrator.

7. The information processing apparatus according to claim 6, wherein
the processor creates the external control application in which a user specifying information for specifying a user designated by the administrator is set, and
the external control application operates in the external device used by the user specified by the set user specifying information.

8. The information processing apparatus according to claim 1, wherein
the processor further distributes the created external control application by a distribution method designated by the administrator.

9. The information processing apparatus according to claim 1, further comprising:
at least one of a scanner reading an image and a printer forming an image on an image receiving medium.

10. A method for creating an external control application controlling an information processing apparatus, comprising:
providing a selection screen for selecting, at an external device, a function realized by the external control application; and
creating the external control application executable by the external device communicating with the information processing apparatus in response to a content designated by an administrator on the selection screen, wherein the external control application controls the information processing apparatus from the external device.

11. The method according to claim 10, further comprising:
creating the external control application having a function of changing a setting item designated by the administrator to a value designated by a user on the external device.

12. The method according to claim 10, further comprising:
creating the external control application having a function of enabling information designated by the administrator to be browsed on the external device.

13. The method according to claim 10, further comprising:
creating the external control application that operates effectively in a usable period designated by the administrator.

14. The method according to claim 10, further comprising:
creating the external control application that is usable by the user designated by the administrator.

15. The method according to claim 14, further comprising:
creating the external control application in which a user specifying information for specifying a user designated by the administrator is set, and
operating in the external device by the set user specifying information.

16. The method according to claim 10, further comprising:
distributing the created external control application by a distribution method designated by the administrator.

17. A system for controlling an information processing apparatus, comprising:
an external device comprising an external device processor and a display,
the external device processor configured to display a management screen on the display, and
the display configured to display options for selecting a creation processing of an external control application on the management screen; and
the information processing apparatus comprising:
a communication interface configured to communicate with the external device; and
an information processing apparatus processor configured to provide a selection screen for selecting, at the external device, a function realized by the external control application and create the external control application executable by the external device in response to a content designated by an administrator on the selection screen, wherein the external control application controls at least one function of the information processing apparatus.

18. The system according to claim 17, wherein the information processing apparatus further comprises:
a memory configured to store the external control application in an initial state, wherein
the information processing apparatus processor creates the external control application executable by the external device by updating the external control application in the initial state stored in the memory in response to the content designated by the administrator.

19. The system according to claim 17, wherein
the information processing apparatus processor creates the external control application having a function of changing a setting item designated by the administrator to a value designated by a user on the external device.

20. The system according to claim 17, wherein
the information processing apparatus processor creates the external control application having a function of enabling information designated by the administrator to be browsed on the external device.
